(19) United States
(12) Patent Application Publication
(10) Pub. No.: US 2010/0303119 A1
(43) Pub. Date: Dec. 2, 2010

(54) Microfluidic Lasers

(75) Inventors: Brian T. Mayers, Somerville, MA (US); Richard S. Conroy, Cheverly, MD (US); Dmitri V. Vezenov, Center Valley, PA (US); Preston Snee, Cambridge, MA (US); Yinthai Chan, Cambridge, MA (US); Moungi G. Bawendi, Cambridge, MA (US); George M. Whitesides, Newton, MA (US)

Correspondence Address: Harvard University & Medical School;c/o Wolf, Greenfield & Sacks, P.C., 600 Atlantic Avenue, Boston, MA, 02210-2206, US

(73) Assignees: President and Fellows of Harvard College, Cambridge, MA (US); Massachusetts Institute of Technology, Cambridge, MA (US)

(21) Appl. No.: 11/794,919

(22) PCT Filed: Feb. 8, 2006
(86) PCT No.: PCT/US06/04577

§ 371 Date: Mar. 15, 2010

Related U.S. Application Data
(60) Provisional application No. 60/650,844, filed on Feb. 8, 2005.

(51) Int. Cl. H01S 3/213; H01S 3/05; H01S 3/20

(52) U.S. Cl. 372/53; 372/54; 372/51

(57) ABSTRACT

The present invention generally relates to lasers comprising fluidic channels, such as microfluidic channels. In some instances, the channel contains two or more fluids. The fluids may remain non-mixed within the channel, for example, due to immiscibility and/or laminar flow within the channel. The fluids may be arranged in the channel such that light propagating in a first fluid is prevented by the second fluid from exiting the first fluid, for example, due to differences in the indexes of refraction (e.g., causing internal reflection of the fluid to occur). Thus, in one embodiment, a first fluid may be at least partially surrounded by a second fluid having a second index of refraction lower than the index of refraction of the first fluid. In some embodiments, the fluidic channel is used as a laser, for instance, a dye laser, i.e., a laser created by directing light at a dye to produce coherent light. The dye may be present in one or more fluids within the fluidic channel. The incident light (for example, created by another laser) may be directed at the channel from any angle. In some cases, laser light may be produced in a direction substantially aligned with the longitudinal axis of the channel. In some embodiments, the laser is free of mirrors, prisms, or gratings, or the laser may produce coherent light using a non-resonant photonic pathway. However, in other cases, mirrors, prisms, or gratings may be used to reflect light along the channel to enhance stimulated emission of coherent light. Another aspect of the invention includes optical diffractors, such as prisms or gratings, which can contain a fluid. The optical diffractors, in certain embodiments, are positioned to diffract light, such as coherent light, emanating from the fluidic channel. Still other aspects of the invention provide devices, kits, and methods of making and using such lasers.

### RELATED APPLICATIONS

This application claims the benefit of U.S. Provisional Patent Application Ser. No. 60/650,844, filed Feb. 8, 2005, entitled “Microfluidic Lasers,” by Mayers, et al., incorporated herein by reference.

### FIELD OF INVENTION

The present invention generally relates to lasers comprising fluidic channels, such as microfluidic channels.

### BACKGROUND

Waveguides are used to deliver electromagnetic radiation, such as signals, across distances. Optical fibers are one example of known waveguides. A typical optical fiber is a long, thin strand of glass including a glass core where the light travels, a cladding surrounding the core of refractive index lower than that of the core that tends to confine the light within the core, optionally additional cladding layers, and optionally an outer coating that protects the fiber from damage and moisture. The light in an optical fiber can be made to travel through the core with high spatial confinement and low loss via internal reflection resulting from the refractive index difference between the core and the cladding.

Optical waveguides that include a liquid core and/or cladding are known. U.S. Pat. No. 5,194,915 to Gilby describes a dual layer liquid flow stream wherein a sample liquid is positioned within a central portion of the stream, while a sheath liquid, of lower refractive index, is provided which surrounds the sample liquid. Under conditions of laminar flow, a smooth boundary exists between the sample and sheath liquids through the region of interest. A narrow beam of light is directed along the axis of the flowing stream, so that it enters the sample liquid and is contained within it by total internal reflection at the boundary between the sample and sheath liquid. The flowing streams therefore act as an optical waveguide for a beam of light which excites fluorescence in the sample. Waveguides having a liquid core and a rigid solid cladding are also known, as described in O. J. A. Schueller, X.-M. Zhao, G. M. Whitesides, S. P. Smith, M. Prentiss, Adv. Matter, 11, 37 (1999).

While the above-described devices represent significant advances in optical waveguides, improvements are still needed.

### SUMMARY OF THE INVENTION

The present invention generally relates to fluidic lasers, and lasers arranged in microfluidic channels. The subject matter of the present invention involves, in some cases, interrelated products, alternative solutions to a particular problem, and/or a plurality of different uses of one or more systems and/or articles.

In one aspect, the invention is a method including an act of establishing lasing radiation in a liquid waveguide, contained within a microfluidic channel, comprising a first liquid defining a core and a second liquid surrounding the core and defining a cladding

In another aspect, the invention provides an apparatus. In one set of embodiments, the apparatus includes a laser comprising a microfluidic channel. In some embodiments, the laser is free of mirrors, prisms, or gratings. The laser, in some cases, is able to produce coherent light using a non-resonant photonic pathway. In certain instances, the microfluidic channel contains a first liquid and a second liquid not mixed with the first liquid. In one embodiment, the microfluidic channel is a microfluidic channel waveguide having a core region and a cladding region, where the core region and/or the cladding region may comprise a liquid.

According to another set of embodiments, the apparatus includes a first laser comprising a microfluidic channel defining a longitudinal axis, and a second laser directed at the microfluidic channel of the first laser. In some cases, the first laser is able to produce coherent light in a direction substantially aligned with the longitudinal axis of the first laser. In certain embodiments, the laser may have a lasing cavity having a largest dimension of at least about 5 mm.

In one set of embodiments, the apparatus includes a fluidic waveguide defining a longitudinal axis, and an optical diffractor constructed and arranged to diffract a select, predetermined portion of a spectrum of light exiting the fluidic waveguide back into the fluidic waveguide in a direction substantially along the longitudinal axis of the waveguide. In another set of embodiments, the apparatus includes a fluidic channel defining a longitudinal axis able to transmit a spectrum of light, the fluidic channel comprising an array of features constructed and arranged to diffract a select, predetermined portion of the spectrum of light in a direction substantially along the axis of the waveguide. In still another set of embodiments, the apparatus includes a microfluidic channel defining a longitudinal axis, the microfluidic channel comprising an array of features distributed within the microfluidic channel so as to diffract light propagating in the microfluidic channel, where the propagating light, prior to diffraction, propagates in a direction substantially aligned with the longitudinal axis.

In another aspect, the present invention is directed to a method of making one or more of the embodiments described herein, for example, a laser comprising a microfluidic channel. In yet another aspect, the present invention is directed to a method of using one or more of the embodiments described herein, for example, a laser comprising a microfluidic channel. In still another aspect, the present invention is directed to a method of promoting one or more of the embodiments described herein, for example, a laser comprising a microfluidic channel.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are schematic diagrams of various embodiments of the invention;

FIGS. 2A-2C illustrate emission of a microfluidic laser, according to another embodiment of the invention;

FIG. 3 illustrates fabrication of a mirror on a microfluidic laser, in accordance with yet another embodiment of the invention;

FIGS. 4A-4B illustrate diffusion within a microfluidic channel, in accordance with another embodiment of the invention;

FIG. 5 is a graph illustrating intensity versus power, in yet another embodiment of the invention;

FIGS. 6A-6B illustrate the transition from spontaneous to stimulated emission in another embodiment of the invention;

FIGS. 7A-7B are schematic diagrams illustrating the geometry of still another embodiment of the invention;

FIGS. 8A-8B illustrate spontaneous emission in yet another embodiment of the invention;

FIG. 9 illustrates output pulse energy versus input pulse energy, in accordance with still another embodiment of the invention;

FIGS. 10A-10D illustrate components for feedback control according to certain embodiments of the invention;

FIGS. 11A-11B illustrate certain other embodiments of the invention; and

FIGS. 12A-12C illustrate the tuning of certain microfluidic lasers of the invention.

### DETAILED DESCRIPTION

The present invention involves a laser that includes at least one fluid waveguide component which can be a microfluidic component, and can be supported via a microfluidic channel. In some instances, the channel contains two or more fluids which can remain non-mixed within the channel during operation of the laser, for example due to immiscibility and/or laminar flow within the channel. The fluids may be arranged in the channel such that light is guided by and substantially confined within a first fluid by the presence of a second fluid due to sufficient differences in the indices of refraction (e.g., causing internal reflection of the fluid to occur). The use of a fluid or fluids in the establishment of a laser allows for the composition, size, and/or placement of optical components of devices of the invention to be changed. Such changes can result in the establishment of different types of lasers using a common set of apparatuses, and changes in laser properties can be made during use of the laser.

Thus, in one embodiment, a laser of the invention includes a first fluid at least partially bounded by, e.g. surrounded by a second fluid having a second index of refraction lower than the index of refraction of the first fluid. In some embodiments, a dye laser is formed, i.e., a laser created by directing light at a dye to produce coherent light. The dye may be present in one or more fluids within the fluidic channel. The incident light (for example, created by another laser) may be directed at the channel from any angle, and laser light can be produced in a direction substantially aligned with the longitudinal axis of the channel.

In some embodiments, the laser is free of mirrors, prisms, gratings, or other optical apparatus that can select a wavelength or subset of wavelengths from broader incident radiation, or the laser may produce coherent light using a non-resonant photonic pathway. However, in other cases, mirrors, prisms, gratings or other selection apparatus may be used to reflect light along the channel to enhance stimulated emission of coherent light. Optical diffractors, such as prisms or gratings, which contain a fluid can be used with the invention. Still other aspects of the invention provide devices, kits, and methods of making and using such lasers.

The following applications are incorporated herein by reference: U.S. Provisional Patent Application Ser. No. 60/650,844, filed Feb. 8, 2005, entitled “Microfluidic Lasers,” by Mayers, et al.; U.S. Provisional Patent Application Ser. No. 60/592,920, filed Jul. 30, 2004, entitled “Fluid Waveguide,” by Wolfe, et al.; and U.S. Provisional Patent Application Ser. No. 60/625,861, filed Nov. 8, 2004, entitled “Broadband Light Sources in Fluid Waveguides,” by Wolfe, et al.

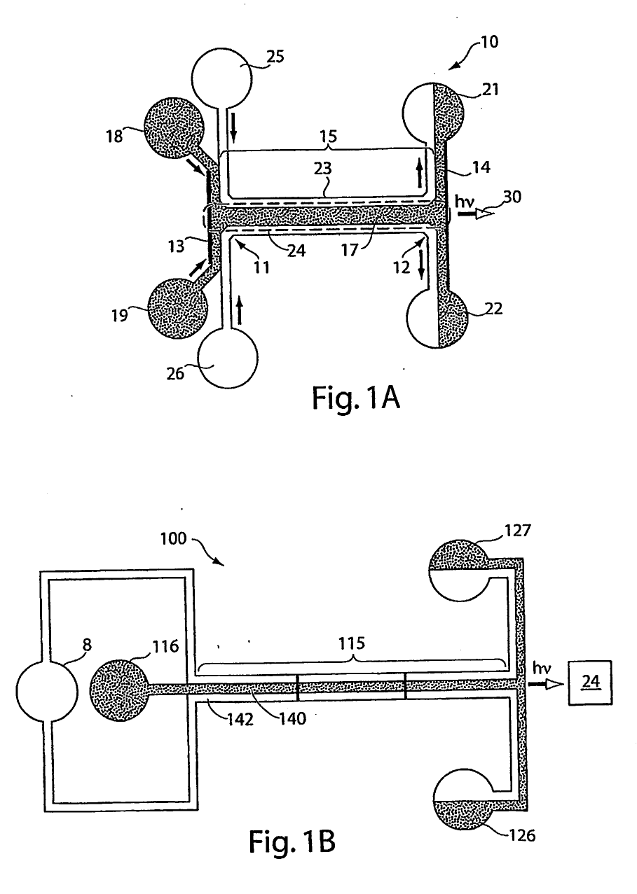

In accordance with the present invention a fluidic channel, such as a microfluidic channel, or at least a portion thereof, may define a lasing cavity, i.e., a region in which coherent light may be produced, for example, by optical or electrical excitation of a dye or other fluorescent entity present within the lasing cavity. One embodiment of the invention in the form of a device 10 is illustrated in FIG. 1A. In this figure, device 10 includes a lasing cavity 15 defined by a fluid channel including a series of inlets and outlets arranged to establish, within the fluid channel, a fluid waveguide core surrounded by a fluid cladding, and the device includes or is used in conjunction with a source of energy able to stimulate the lasing cavity to lase. The energy source can be a source of laser light.

Specifically, device 10 includes a set of inlets 18, 19, 25, and/or 26, generally at one end thereof, through which fluid or various fluids can be introduced, and at least one outlet, such as two outlets 21 and/or 22 (and/or additional outlets) through which fluid can be made to exit the waveguide portion of the guide. As used herein, “inlet” means any component, channel, opening, port, or apparatus that allows a fluid to be introduced into the device or channel. An inlet does not have to be permanently accessible, as some embodiments may include inlets that are openable and closeable, for example, using valves. As illustrated in FIG. 1A, device 18 has 4 inlets and 2 outlets; however, in other embodiments of the invention, more or fewer inlets and/or outlets may be present, depending on the particular application (for example, FIG. 1B, discussed below, illustrates another embodiment of the invention having two inlets 116, 118 and two outlets 126, 127). Referring again to FIG. 1A, lasing cavity 15 includes a channel through which two or more fluids can flow. One or more of the fluids within the channel may include a dye or other fluorescent entity that, when stimulated (e.g., through incident light), is able to produce coherent radiation 30 (“hυ”) that is directed along the longitudinal axis of the channel and exits an end of the channel. While not required, mirrors, prisms, or gratings may be used to enhance the stimulated emission of coherent light in some cases, and/or to control the bandwidth or distribution of frequencies of coherent light emitted by the device. For instance, in FIG. 1A, device 10 is depicted as including mirrors 13 and 14 on either side of lasing cavity 15.

As described more fully below, the various inlets and outlets can be used to establish lasers with differing dye components resulting in different spectral output, different size and/or position of core relative to cladding, affecting the modal properties of the laser and other properties, and the like, and such changes can be made during use of the laser.

As used herein, a “channel” is a conduit associated with a device that is able to transport one or more fluids from one location to another, for example, from an inlet to an outlet of the device. One, two, or more fluids may flow through the channels, continuously, randomly, intermittently, etc. The channel may be a closed channel, or a channel that is open, for example, open to the external environment surrounding the device. The fluid(s) within the channel may partially or completely fill the channel. In some cases the fluid(s) may be held or confined within the channel or a portion of the channel in some fashion, for example, using surface tension (i.e., such that the fluid is held within the channel within a meniscus, such as a concave or convex meniscus). The channel may have any suitable cross-sectional shape that allows for fluid transport, for example, a square channel, a circular channel, a rounded channel, a rectangular channel (e.g., having any suitable aspect ratio), a triangular channel, an irregular channel, etc. The channel may be of any size within the device. For example, the channel may have a largest dimension perpendicular to a direction of fluid flow within the channel of less than about 1000 micrometers in some cases (i.e., a “microfluidic” channel), less than about 500 micrometers in other cases, less than about 400 micrometers in still other cases, less than about 300 micrometers in still other cases, less than about 200 micrometers in still other cases, less than about 100 micrometers in still other cases, or less than about 50 or 25 micrometers in still other cases. In some embodiments, the dimensions of the channel may be chosen such that fluid is able to freely flow through the channel. The dimensions of the channel may also be chosen in certain cases, for example, to allow a certain volumetric or linear flow rate of fluid within the channel. Of course, the number of channels, the shape or geometry of the channels, and/or the placement of channels within the device can be determined by those of ordinary skill in the art.

In some embodiments, the fluidic channel (or the device containing the fluidic channel) may be designed to facilitate the coupling of an optical fiber to the channel so that electromagnetic radiation may be introduced to the lasing cavity. For example, light (e.g., from a laser) may be applied using the optical fiber to the lasing cavity to excite a dye or other fluorescent entity present within the lasing cavity, as further discussed below. Those of ordinary skill in the art will be able to position the optical fiber relative to the fluidic channel to achieve this coupling.

The channel can contain any number of fluids. For instance, the channel may contain two fluids, three fluids, four fluids, etc. As used herein, the term “fluid” generally refers to a substance that tends to flow and to conform to the outline of its container. Typically, fluids are materials that are unable to withstand a static shear stress, and when a shear stress is applied, the fluid experiences a continuing and permanent distortion. The fluid may have any suitable viscosity that permits at least some flow of the fluid. Examples of fluids include liquids and gases. Thus, the two or more fluids may be, for example, two or more flowing liquids, two or more flowing gases, one or more flowing liquids and one or more flowing gases, etc. Although much of the description herein is given in the context of liquid fluids, it is to be understood that in all such cases the invention can be used with another fluid, such as a gas.

The two or more fluids within the channel may comprise a continuous flow of liquids. The continuous flow may allow the fluids within the channel to be changed or dynamically adapted (e.g., in real time, such as in response to a changing stimulus), for example, by changing the composition and/or flow rate of one or more of the fluids within the channel. The fluids may be introduced into the channel, in some cases, using a microfluidic network configured to allow the liquids to flow adjacent to one another. Thus, by manipulating the flow rates and/or the composition of the fluids, the characteristics of the optical systems may be dynamically controlled as desired. For instance, in some embodiments, the optical properties (e.g., refractive index, absorption, fluorescence, etc.) and/or the physical properties (e.g., magnetic susceptibility, electrical conductivity, etc.) of one or more fluids within the channel may be changed readily, continuously, and/or independently, by changing the characteristics of the introduced fluids. For example, by changing the optical properties of the fluids, the type of light delivered or generated by the channel may be changed. When changing compositions, a property of a fluid may be changed as a function of time, for example a gradual change in the concentration of a dye within the fluid may be effected. Step changes, i.e., changes in fluid property values that occur in a short amount of time, also may be used to change the composition and/or concentrations in the fluid. In some embodiments, increasing the fluid flow rates of one or more of the fluids within the channel may be used to decrease diffusion between the fluids within the channel.

In certain cases, the two or more fluids may remain generally separate within the channel, i.e., the fluids do not mix. For instance, the fluids may be essentially immiscible (i.e., immiscible on a time scale of interest). Examples of essentially immiscible fluids include a hydrophobic liquid and a hydrophilic liquid, where the hydrophilic liquid has a greater affinity to water than does the hydrophobic liquid. Examples of hydrophilic liquids include, but are not limited to, water and other aqueous solutions comprising water, such as cell or biological media, salt solutions, etc., as well as other hydrophilic liquids such as ethanol. Examples of hydrophobic liquids include, but are not limited to, oils such as hydrocarbons, silicone oils, mineral oils, fluorocarbon oils, organic solvents, dimethyl sulfoxide, methanol, ethylene glycol, propylene glycol, etc.

In some embodiments, laminar flow of the two or more fluids within the channel may prevent or at least inhibit their mixing within the channel, for example, if the channel is a microfluidic channel, or otherwise encourages laminar flow within the channel (e.g., the Reynolds numbers of the fluids within the channel may be such that the fluids exhibit laminar, or at least non-turbulent, behavior). In some embodiments, the two or more fluids may be able to maintain a stable interface relative to each other. The fluids contained within the channel may flow co-currently, or exhibit countercurrent flow in some cases. The fluid flow rates for each fluid may be identical or similar, or substantially different. In some embodiments, one or more of the fluids may be stationary, while the other fluids may flow at a certain flow rate. A fluid may also flow intermittently, or not at all, in certain instances. In one embodiment, a first fluid may be surrounded or at least partially surrounded by a second fluid. In another embodiment, a first fluid may be positioned adjacent a second fluid (and in some cases, a third fluid, etc.). In some cases, the fluids are co-axial within the channel; however, in other cases, differences in the densities of the fluids within the channel may cause the fluids to not be co-axial.

As mentioned, in some embodiments, a fluid stream may be at least partially surrounded by another fluid stream within the channel. For example, with reference to FIG. 1B, a first fluid stream 140 is at least partially surrounded by a second fluid stream 142 within lasing cavity 115, addressed by inlets and outlets in sufficient number to provide a desired liquid arrangement in the cavity. In cases such as this, the first fluid stream may also be referred to as a “core” fluid and the second fluid stream may be referred to as a “cladding” fluid. In some embodiments, the core fluid may surround the cladding fluid and, e.g., form a ring around the cladding fluid. In other embodiments, however, the core fluid does not completely surround the cladding fluid.

In some embodiments, the two or more fluids within the channel may be chosen on the basis of differences in their indexes of refraction. For example, differences in the indexes of refraction of the core fluid and the cladding fluid may provide the ability to guide light within the core fluid, for example, if the core fluid has a higher index of refraction, relative to the cladding fluid. Thus, light propagating within the core fluid may be directed within the core fluid and inhibited from exiting the core fluid, due to the lower index of refraction of the cladding fluid relative to the core fluid. Thus, the indexes of refraction of the two or more fluids may be chosen to allow the fluids within the channel to act as an optical waveguide, i.e., a structure in which electromagnetic radiation, such as light, can be guided. For instance, the core fluid may be chosen to have a higher index of refraction, as compared to the cladding fluid. As used herein, “guiding” means providing a pathway such that a significant amount of electromagnetic radiation proceeds along the pathway. Of course, it is expected that some percentage of radiation will degrade or be lost from the pathway via scattering or other means. Non-limiting examples of optical waveguides include those disclosed in U.S. Provisional Patent Application Ser. No. 60/592,920, filed Jul. 30, 2004, entitled “Fluid Waveguide,” by Wolfe, et al., incorporated herein by reference. In certain instances, laminar fluid flows may generate an intrinsically generally optically smooth interface between the core fluid and the cladding fluid, and in such an arrangement the smoothness of the supporting solid channel walls may not be critical. For example, when the roughness of the channel walls is less than 5% of the total width of the channel, the effect of the roughness may be negligible on the core and cladding fluid interfaces.

It should be noted that, where liquid waveguide techniques of the invention involve, for example, changing or controlling the concentration of a particular species in the liquid, those of ordinary skill in the art will be able to adapt the technique to fluids that are gases without undue experimentation. The formation of adjacent fluid streams exhibiting laminar flow is discussed in, e.g., U.S. Pat. No. 6,719,868, issued Apr. 13, 2004 to Schuler, et al., and U.S. Pat. No. 6,653,089, issued Nov. 25, 2003 to Takayama, et al., each of which is hereby incorporated herein in its entirety.

The fluidic channel, in some embodiments, is used to generate coherent light, i.e., the fluidic channel, or at least a portion thereof, acts as a lasing cavity, which generates the coherent light. The fluidic channel may generate coherent light through an amplified stimulated emission (“ASE”) process. Thus, the device containing the fluidic channel acts as a laser, i.e., the device is able to emit amplified and coherent electromagnetic radiation having one or more discrete frequencies, typically in response to an electrical and/or an electromagnetic stimulus (e.g., incident light, or “stimulation” light). Typically, the coherent light produced has a relatively narrow range of wavelengths or frequencies, i.e., the coherent light is substantially monochromatic. For example, the substantially monochromatic light produced by the laser may have a full width at half maximum (“FWHM”) of less than about 25 nm (wavelength), and in some cases, the FWHM may be less than about 20 nm, less than about 15 nm, less than about 10 nm, less than about 7 nm, less than about 5 nm, or less than about 3 nm. In some cases, at least about 80%, at least about 85%, at least about 90%, at least about 95%, at least about 97%, or at least about 99% of the wavelengths comprising the coherent light may be within 5 nm or 3 nm of the average wavelength of the light.

It should be noted that the invention is not limited to lasers having a channel containing two fluids that form a waveguide that acts as a lasing cavity. In other embodiments, three, four, or more fluids may be present within the channel, and in other embodiments, a waveguide that acts as a lasing cavity may be formed between a core fluid and a solid cladding, a solid core and a fluid cladding, etc. In many cases, the core (which may be a solid, or fluid) is chosen to have a higher index of refraction than the cladding (which may be a solid, or fluid). Thus, in some embodiments, portions of the waveguide may include a core region positioned adjacent to the walls of the channel, for example, at the top and/or bottom of the channel, etc., such that the channel wall contacts the core, and in this arrangement, both the channel wall of the supporting structure and the fluid cladding can act together as a cladding or claddings to direct light along the channel. As used herein, “adjacent” means nearby. The term “adjacent” is not meant to require a common border or interface, but can include a common border or interface. For example, a cladding fluid may be adjacent to a core fluid even if a third component such as a thin solid or an additional liquid stream is interposed between the cladding fluid and the core fluid.

As used herein, the term “light” generally refers to electromagnetic radiation, having any suitable wavelength (or equivalently, frequency). Thus, where “light” is used in describing a particular embodiment of the invention, it is to be understood this is not limited to visible light. For instance, in some embodiments, the light may include wavelengths in the visual range (for example, having a wavelength of between about 400 nm and about 700 nm), infrared wavelengths (for example, having a wavelength of between about 300 micrometers and 700 nm), ultraviolet wavelengths (for example, having a wavelength of between about 400 nm and about 10 nm), or the like. The light may have a single wavelength, or include a plurality of different wavelengths. For instance, in some cases, the light may have a range of wavelengths between about 350 nm and about 1000 nm, between about 300 micrometers and about 500 nm, between about 500 nm and about 1 nm, between about 400 nm and about 700 nm, between about 600 nm and about 1000 nm, between about 500 nm and about 50 nm, etc. As non-limiting examples, the light may be substantially monochromatic, with a range of wavelengths centered around 366 nm, 405 nm, 436 nm, 546 nm, 578 nm, 457 nm, 488 nm, 514 nm, 532 nm, 543 nm, 594 nm, 633 nm, 568 nm, 647 nm, etc.

The coherent light may be produced by a process of exciting atoms or molecules within the lasing cavity of the laser into a metastable “excited” energy state (for example, due to electromagnetic radiation and/or electrical stimulation), such that these excited atoms or molecules are able to decay to a lower energy level, releasing photons. The release of photons may induce other atoms or molecules into releasing additional photons at substantially the same wavelength or frequency, thus producing a coherent beam of electromagnetic radiation, which may then be emitted (“lased”) from the lasing cavity.

Excitation of the atoms or molecules within the lasing cavity into the metastable state may be caused by directing energy, such as electromagnetic radiation, at the lasing cavity (or a portion thereof). In some embodiments, electromagnetic radiation of the visual spectrum may be used; in other embodiments, however, other electromagnetic radiation, such as infrared or ultraviolet radiation, may be used. “Optically-driven” lasers can be formed in accordance with the invention, meaning a laser that is powered by directing electromagnetic energy from an electromagnetic radiation source at a lasing cavity to produce the metastable excited state. The radiation source may be any suitable source, for example, a flash tube, a diode, or another laser. For example, in one embodiment, the excitation laser is a Nd:YAG laser. As other non-limiting examples, the laser directed at the lasing cavity may be a ruby laser or other solid-state laser, a gas laser (e.g., a helium or a helium-neon laser, an argon ion laser, or the like), an excimer laser, a dye laser, a semiconductor laser or a diode laser, etc.

One set of embodiments of the present invention is directed to a dye laser, i.e., a laser that produces coherent light using one or more organic molecules in solution or suspension as the lasing media. One or more of the fluids contained within the channel may contain the organic molecules. In some cases, fluorescent molecules or other entities can be used as the lasing media. The concentration of the dye may be any suitable concentration that allows the dye laser to lase, and can be determined for a particular application or geometry using no more than routine experimentation. Non-limiting examples of potentially suitable dyes include, but are not limited to, rhodamine (e.g., rhodamine 640 perchlorate, rhodamine 6G, rhodamine B, rhodamine 590, rhodamine 700, rhodamine 800, etc.), perylene, fluorescein (e.g., disodium fluorescein), sulforhodamine B, coumarin 460, etc. Other non-limiting examples of dyes include oxazine 170 perchlorate; 1,4-bis(2-methylstyryl)benzene; 1,4-bis(2-methylstyryl)benzene; 1,4-bis(5-phenyl-2-oxazolyl)benzene; carbostyril 124; 7-diethylamino-4-methylcoumarin; 3,3′-diethyloxacarbocyanine iodide; 3,3′-diethylthiacarbocyanine iodide; 2-[5-(1,3-dihydro-1,3,3-trimethyl-2h-indol-2-ylidene)-1,3-pentadienyl]-1,3,3-trimethyl-3h-indolium iodide; 2-[4-(dimethylamino)styryl]-1-methylpyridinium iodide; Nile blue a perchlorate; 2,2′-bipyridine-3,3′-diol; oxazine 1 perchlorate; 5-phenyl-2-(4-pyridyl)oxazole; rhodamine 6 g perchlorate; styryl 7; styryl 9M; styryl 9M tetrafluoroborate; sulforhodamine G; 2,5-diphenyloxazole; 1,4-bis(4-methyl-5-phenyl-2-oxazolyl)benzene; 2,5-bis(5-tert-butyl-benzoxazol-2-yl)thiophene; 7-amino-4-methylcoumarin; 3,3′-(4,4′-biphenylene)bis(2,5-diphenyl-2h-tetrazolium chloride); 2-(4-biphenylyl)-6-phenylbenzoxazole; 2-(4-biphenylyl)-5-(4-tert-butylphenyl)-1,3,4-oxadiazole; 2-(4-biphenylyl)-5-phenyl-1,3,4-oxadiazole; 4-(dicyanomethylene)-2-methyl-6-(4-dimethylaminostyryl)-4H-pyran; 2,5-diphenyl-1,3,4-oxadiazole; 5-(4-pyridyl)-1,3,4-oxadiazole-2-thiol; 5-phenyl-1,3,4-oxadiazole-2-thiol; 5-phenyl-1,3,4-oxadiazole-2-thiol; 5-(4-methylphenyl)-1,3,4-oxadiazole-2-thiol; 5-(4-methoxyphenyl)-1,3,4-oxadiazole-2-thiol; 2,5-diphenyl-1,3,4-oxadiazole; 4-chloro-7-chlorosulfonyl-2,1,3-benzoxadiazole; 2-(4-bromophenyl)-5-phenyl-1,3,4-oxadiazole; 2,5-bis-(4-aminophenyl)-1,3,4-oxadiazole; 2-(4-biphenylyl)-5-phenyl-1,3,4-oxadiazole; 2-(4-biphenylyl)-5-(4-tert-butylphenyl)-1,3,4-oxadiazole; 2,1,3-benzoxadiazole-5-carboxylic acid; 1,3-bis[4-(dimethylamino)-2-hydroxyphenyl]-2,4-dihydroxycyclobutenediylium dihydroxide, bis(inner salt); bis[5-[[4-(dimethylamino)phenyl]imino]-8(5H)-quinolinone]nickel(ii); 1,1′-diethyl-4,4′-carbocyanine iodide; 1,1′-diethyl-2,2′-dicarbocyanine iodide; 1,1′-diethyl-4,4′-dicarbocyanine iodide; 1,1′-diethyl-2,2′-quinotricarbocyanine iodide; 3,3′-diethylthiadicarbocyanine iodide; 3,3′-diethylthiatricarbocyanine perchlorate; 3,3′-diethylthiatricarbocyanine iodide; 2,4-di-3-guaiazulenyl-1,3-dihydroxycyclobutenediylium dihydroxide bis(inner salt); dimethyl{4-[1,7,7-tris(4-dimethylaminophenyl)-2,4,6-heptatrienylidene]-2,5-cyclohexadien-1-ylidene}ammonium perchlorate; dimethyl{4-[1,5,5-tris(4-dimethylaminophenyl)-2,4-pentadienylidene]-2,5-cyclohexadien-1-ylidene}ammonium perchlorate; 1,1′,3,3,3′,3′-hexamethylindotricarbocyanine iodide; 1,1′,3,3,3′,3′-hexamethylindotricarbocyanine perchlorate; indocyanine green; IR-27; IR-1040; IR-1048; IR-1050; IR-1051; IR-1061; IR-1100; IR-140; IR-676; IR-676 iodide; IR-746; IR-775 chloride; IR-783; IR-797 chloride; IR-797 perchlorate; IR-806; IR-813 chloride; IR-813 perchlorate; IR-820; naphthol green B; propyl astra blue iodide; or the like.

In certain embodiments where a channel defining a waveguide (e.g., having a core fluid, and a cladding fluid) is used as the lasing cavity of a dye laser, coherent light produced by the dye may be directed substantially along the longitudinal axis of the channel (e.g., due to the waveguiding properties of the channel), such that the laser produces light in a direction substantially aligned with the longitudinal axis of the channel. As used herein, the “longitudinal axis” of an article is defined as the axis along the largest dimension of the article.

A variety of general features and options are now provided in accordance with certain embodiments of the invention. For instance, as described above, the flow of fluid within the lasing cavity may be used to replace and/or change the dye molecules within the lasing cavity (e.g., using dyes that are the same or different). For example, some dyes degrade via photobleaching, and the addition of new dyes to the fluid flows may help to maintain the dye concentration at a suitable level.

As another example, in some cases, the wavelength or frequency of the coherent light produced by the lasing cavity may be controlled as desired, for example, from a first wavelength or frequency to a second wavelength or frequency, by changing the composition and/or concentration of one or more dyes or other fluids within the channel, and/or by changing the flow rate of one or more of the fluids within the channel. The composition may be changed, for instance, by adding or removing a dye to the fluid, by changing the concentration of dye within the fluid, by changing the solvent or solvent ratio of the fluid containing the dye (e.g., from a first ratio of a first solvent to a second solvent to a second ratio, etc.). Other changes can be made, such as changing the refractive index of one or more fluids of the device. Geometrical changes can be made to a laser of the invention as well, i.e. moving the core to a different position in the cladding, increasing or decreasing the size of the core relative to the cladding, or the like. As mentioned, these changes can be made between uses of the laser (i.e., changes between uses that result in uses of different lasers before and after the change(s), or during use of the laser, i.e., the spectral and/or modal output of a laser can be made to change during use). Changes can be made by altering the nature, and/or amount (pressure or vacuum) of fluid entering the device through one or more inlets. Altering pressure of inlet fluids relative to each other can be used to control position and/or size of fluid components.

The lasing cavity may have any suitable dimension such that electromagnetic radiation or electrical stimulation may be directed at least a portion of the lasing cavity to produce a metastable energy state within the lasing cavity. In some embodiments, the lasing cavity is a microcavity, e.g., has a largest dimension, i.e. length, of less than about 1 mm; however, in other embodiments, the lasing cavity may have a largest dimension of at least about 1 mm, and in other cases, at least about 2 mm, at least about 3 mm, at least about 4 mm, at least about 5 mm, at least about 6 mm, at least about 7 mm, at least about 8 mm, at least about 9 mm, or at least about 10 mm. The lasing cavity, in certain instances, may have an aspect ratio (ratio of the largest dimension to the smallest dimension) of at least about 30, at least about 50, at least about 75, at least about 100, at least about 125, or more in some cases. In some cases, the lasing cavity may be stimulated by incident light (e.g., using a laser) having a size or shape large enough to excite at least a portion, or the entirety of, the lasing cavity. For example, if laser light is used to excite the lasing cavity, the laser light may be directed using one or more lenses (for instance, a converging lens, a diverging lens, a plano-convex lens, a piano-concave lens, a double convex lens, a double concave lens, a Fresnel lens, a spherical lens, an aspheric lens, a binary lens, or the like), mirrors (for example, a planar mirror, a curved mirror, a parabolic mirror, or the like), diffraction gratings, prisms, optical fibers, etc., depending on a particular application.

In one set of embodiments, the laser is able to produce coherent light using a non-resonant photonic pathway. That is, the pathway is able to produce coherent light within a laser without requiring the use of resonant phenomena, e.g., utilizing light pathways that resonate between mirrors, prisms, gratings, etc. Such light may be produced using a long lasing cavity, so that the laser is able to produce high gain in a single pass. A long lasing cavity generally does not require the resonating effects of a microcavity in order to reach an excited population state sufficient for coherent light to be produced. As a non-limiting example, a 10 mm lasing cavity produced a light path, in a single pass, that is equivalent to 500 round trips in a 10 micrometer microcavity. Other examples of long lasing cavities have been described above.

In one set of embodiments, coherent light produced by the device is directed at a delivery site, for example, delivery site 24 aligned with the lasing cavity in FIG. 1B. The delivery site may include any apparatus or sites of interest. For example, the light may be directed directly at the delivery site, or an optical fiber may be attached to the device or otherwise positioned relative to the lasing cavity such that light exiting the lasing cavity is coupled into the fiber, which may then be directed at a delivery site. In another example, a chemical, biochemical, or biological reaction or species may be present at the delivery site, and light delivered to the delivery site may be used to analyze the contents of the site (e.g. spectroscopically via infrared, ultraviolet, fluorescence spectroscopy or the like), or the light may be used to promote a chemical or biological reaction at the delivery site (e.g., a photochemical reaction, a reaction stimulated by heat generated by interaction of the light with the delivery site, etc.), or the like. Those of ordinary skill are aware of many ways in which electromagnetic radiation can be used to affect or analyze a chemical, biochemical, or biological species. As another example, collection devices or analysis tools may be present at the delivery site. For instance, the delivery site may comprise a device constructed and arranged to determine a signal carried by electromagnetic radiation. The signal may be electromagnetic radiation, such as light, which, in some embodiments, encodes a time-varying signal. In some cases, by controlling the composition and/or flow rate of one or more of the fluids within the channel, e.g., as previously described, the coherent light directed at the delivery site may be precisely controlled, e.g., the position, intensity, frequency, mode structure, etc. of the coherent light may be controlled as desired. Other examples of directing and controlling light directed at a delivery site are discussed in U.S. Provisional Patent Application Ser. No. 60/592,920, filed Jul. 30, 2004, entitled “Fluid Waveguide,” by Wolfe, et al., incorporated herein by reference.

The various apparatus devices and systems described herein often will include fluid reservoirs and fluid pumps (not shown) to move fluid from the fluid reservoirs to the fluid inlets. Those of ordinary skill in the art are aware of how to arrange such components to practice the invention.

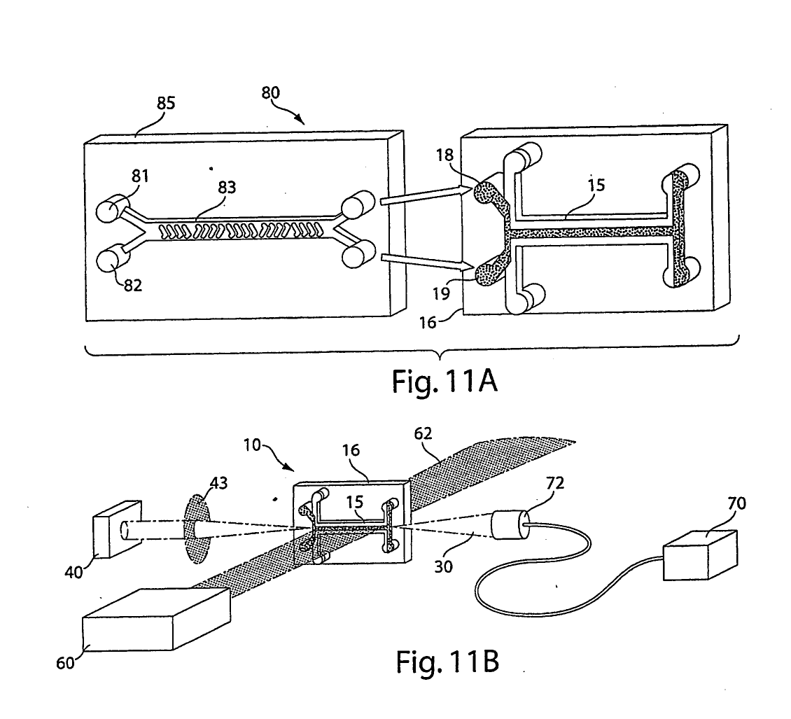

Other fluidic devices may be used in conjunction with the microfluidic laser as well, and such devices may be integrally connected to the microfluidic laser (e.g., on the same substrate), or separate from the microfluidic laser. As a non-limiting example of a mixer used in conjunction with a microfluidic laser, in FIG. 11A, chaotic mixer 80 is illustrated. In this figure, chaotic mixer 80 is present on substrate 85, which is separate from substrate 16 on which microfluidic laser 15 is located. Chaotic mixer 80 mixes two (or more) fluids, which are then passed to a lasing cavity 15, for example, through inlets 18 and 19 in this example. In FIG. 11A, in chaotic mixer 80, a first fluid (e.g., entering input 81) and a second fluid (e.g., entering input 82) are fed to mixing chamber 83, to be mixed together, in some cases forming a homogenous fluid. Of course, in other embodiments, more inputs may be present, e.g., if more than two fluids are mixed together. Within mixing chamber 83 in FIG. 11A, the fluids are mixed due to the presence of chaotic flow, i.e., non-laminar flow, within the mixing chamber. In some cases, mixing chamber 83 may have one or more features to cause chaotic, non-laminar behavior in the fluids therein. For example, one or more posts, baffles, grooves, protrusions, or walls may be used to facilitate chaotic fluid flow within mixing chamber 83. Other examples can be seen in International Patent Application No. PCT/US02/23462, filed Jul. 24, 2002, entitled “Laminar Mixing Apparatus and Methods,” by Stroock, et al., published as WO 03/011443 on Feb. 13, 2003; or U.S. patent application Ser. No. 10/766,108, filed Jan. 27, 2004, entitled “Laminar Mixing Apparatus and Methods,” by Stroock, et al., published as U.S. Patent Application Publication No. 2004/0262223 on Dec. 30, 2004, each incorporated herein by reference. The features within the mixing chamber may be arranged in a regular or an irregular pattern, for example, a rectangular or a hexagonal pattern, or the features may be randomly arranged within the channel. Upon exiting chaotic mixer 80, the fluid may be introduced to lasing cavity 15. For example, the fluid may be introduced as a core fluid or a cladding fluid. If the chaotic mixer is separate from the microfluidic laser, as is depicted in FIG. 11A, the fluid may be introduced through one or more inputs into the microfluidic laser. In some cases, more than one chaotic mixer may be used, for example, a first chaotic mixer may be used form the core fluid, and a second chaotic mixer may be used to form a cladding fluid. In another set of embodiments of the invention, optical components such as mirrors, grating, or diffractors are used in conjunction with lasers of the invention, e.g. to reflect light along a lasing pathway for the establishment of a standing wave, and/or to select a narrow wavelength of light from a broader spectrum. Non-limiting examples of diffractors include diffraction gratings and prisms. In some cases, the diffractor may comprise a fluid, where the light to be diffracted by the diffractor interacts with at least a portion of the fluid. For instance, the fluid may diffract a portion of the light incident on the fluid, and/or the fluid may absorb a portion of the incident light (for example, within a certain set of frequencies). In one embodiment, the fluid within the diffractor is contained within a fluidic channel, such as a microfluidic channel (e.g., as previously described).

The fluid within the diffractor may be altered to alter the diffraction properties of the diffractor. For example, the composition, concentration, and/or flow rate of the fluid within the diffractor may be changed, e.g., through an inlet and an outlet. By controlling the flow rates and/or the composition of the fluid within the diffractor, the characteristics of the diffractor may be dynamically controlled as desired. For instance, certain optical properties (e.g., refractive index, absorption, fluorescence, wavelength or frequency, etc.) of the fluid within the diffractor may be changed readily, continuously, and/or independently by changing the characteristics of the introduced fluids. For example, by changing the optical properties of the fluids, the type of light diffracted by the diffractor may be changed. The fluid may be changed as a function of time, for example, a gradual change in concentration may be effected. Step changes, i.e., changes in fluid property values that occur in a short amount of time, may also be used in some cases.

In one set of embodiments, the diffractor is positioned to diffract a portion of the light exiting a fluidic channel (e.g., a lasing cavity), as previously described, such that only a portion of the light is directed back into the fluidic channel, for instance, in a direction substantially along the longitudinal axis of the fluidic channel. If the diffractor also contains a fluidic channel, the fluidic channel of the diffractor may be positioned such that the exiting light passes through at least a portion of the microfluidic channel.

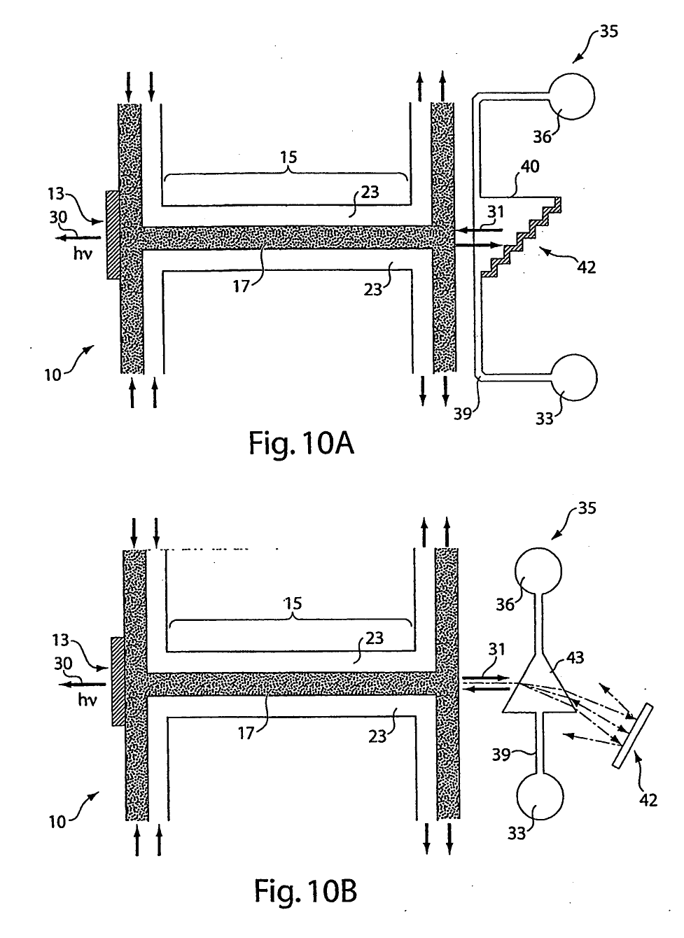

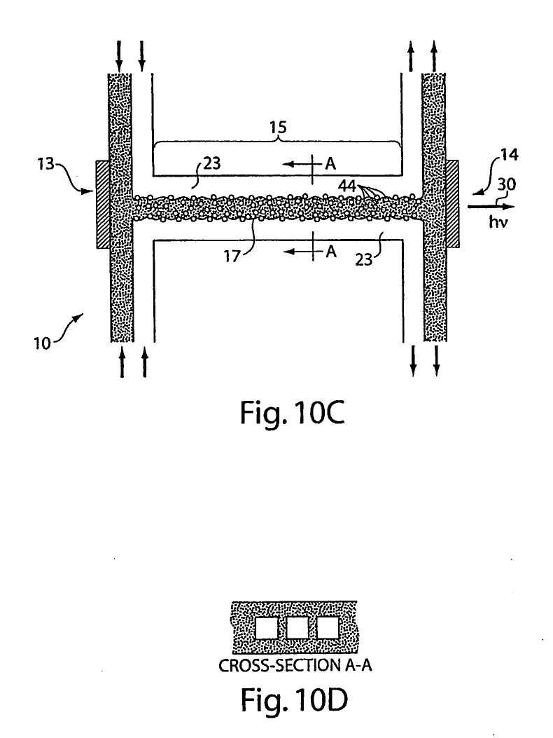

One example of a diffractor, as used in association with a lasing cavity, is illustrated in FIG. 10A. In this figure, device 10 includes an lasing cavity 15, similar to that described above with respect to FIG. 1A. Several inlets and outlets within device 10 allow core fluid 17 and cladding fluid 23 to flow through lasing cavity 15, as illustrated by the arrows indicating the direction of fluid flow. One or more of the fluids within the lasing cavity may include a dye or other fluorescent entity that, when stimulated (e.g., through incident light), is able to produce coherent radiation 30 that is directed along the longitudinal axis of the channel and exits an end of the channel. Optionally, device 10 includes a mirror 13 on one side of lasing cavity 15. Also shown in FIG. 10A is diffractor 35. Diffractor 35 includes an inlet 33, and outlet 36, and a fluidic channel 39. One or more fluids may be introduced into diffractor 35 through inlet 33, and passed through channel 39 to outlet 36. A portion of the light exiting lasing cavity 15, which may be substantially aligned with the longitudinal axis of lasing cavity 15, interacts with fluidic channel 39 and diffraction grating 40, which optionally includes mirror 42. In some cases, the diffraction grating may be used to select the wavelength diffracted and/or reflected back to lasing cavity 15, as is illustrated by arrows 31. The diffractor may be controlled, e.g., to select a wavelength or range of wavelengths to enhance within lasing cavity 15 for production as coherent radiation 30, and can be controlled by controlling the composition and/or flow rate of the fluid within channel 39. Another example of a diffractor is illustrated in FIG. 10B. This embodiment is similar to FIG. 10A, although a prism 43 is used in place of diffraction grating 40. The combination of components shown in FIG. 10A not only selects light of a particular wavelength, but establishes a reflective standing wave of the particular wavelength in the lasing cavity.

Another diffractor of the invention is shown in FIG. 10C. In this embodiment, the diffractor is part of lasing cavity 15 of device 10. The diffractor, in this embodiment, comprising an array of features 44 distributed within the microfluidic channel so as to diffract at least a portion of the light propagating in the fluidic channel. Fluid may flow around or otherwise permeate the array of features within lasing cavity 15 between the inlets and outlets of the fluidic channel. In some cases; the flow may be laminar or otherwise non-disruptive or non-turbulent. Optionally, device 10 may include mirrors 13 and/or 14. The features of the diffractor may be any feature able to diffract at least a portion of the light propagating in the fluidic channel. The features may have a variety of different structures. In some embodiments, the features are posts, for example, as is shown in FIG. 10D, which is a cross-sectional view of the fluidic channel taken across line A-A in FIG. 10C. As used herein, the term “post” refers to any structure that protrudes into a channel. An array of posts may be arranged in a regular or an irregular pattern, for example, a rectangular or a hexagonal pattern, or the posts may be randomly arranged within the channel. The posts may all have identical shapes or sizes, or they may have different sizes, shapes, compositions, or other physical characteristics. The posts may have any shape, for example, pyramidal, conical, spherical, or amorphous. In some embodiments, the posts are cylindrical. The posts may have cross-sections that are square, U-shaped, circular, triangular, or the like. The posts may span the channel, or they may be smaller than the size of the channel.

Another non-limiting example of a grating used with a microfluidic laser is illustrated in FIG. 11B. In this figure, device 10 includes lasing cavity 15 (on substrate 16), having a configuration similar to that described above with respect to FIG. 1A. Lasing cavity 15 may be stimulated using any suitable light source 60 (or other electrical and/or an electromagnetic stimulus), for example, a pump laser, such as a Nd-YAG pump laser. As above, one or more of the fluids within lasing cavity 15 may include a dye or other fluorescent entity that, when stimulated (e.g., through incident light, such as that from pump laser 60 and directed to at least a portion of lasing cavity 15) is able to produce coherent radiation 30 that is directed along the longitudinal axis of lasing cavity 15, and exits one end of the lasing cavity. Coherent radiation 30 that is emitted from lasing cavity 15 may be directed, for example, at a delivery site, as previously described, or other suitable site of interest. For instance, in one embodiment, coherent radiation from lasing cavity 15 may be directed at a detector 72 of spectrometer 70, for example, a fiber-spectrometer, as is illustrated in FIG. 11B.

Also shown in FIG. 11B is grating 40. A portion of the coherent radiation exiting lasing cavity 15, in a direction substantially aligned with the longitudinal axis of lasing cavity 15 (in a direction opposite to the delivery site or other site of interest), interacts with diffraction grating 40. Optionally, the coherent radiation may also be controlled in some manner, for example, using a mirror, or by passing the radiation through a lens 43, as is illustrated in FIG. 11B. In some cases, grating 40 may be used to control the wavelength (or peak wavelength) of the coherent radiation emitted by lasing cavity 15. For instance, grating 40 may only allow certain wavelengths to be reflected back towards lasing cavity 15. In one embodiment, grating 40 may be used to spectrally narrow the emitted radiation from lasing cavity 15, i.e., the grating allows the bandwidth of the emitted radiation to be carefully controlled.

A wide range of materials and methods, according to certain aspects of the invention, can be used to form any of the above-described components of the systems and devices of the invention. In some cases, the various materials selected lend themselves to various methods. For example, various components of the invention can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention can be formed of a polymer, for example, an elastomeric polymer such as polydimethylsiloxane (“PDMS”), polytetrafluoroethylene (“PTFE” or Teflon®), or the like.

In some cases, the polymer may be elastic and/or flexible. For example, the device may be constructed using an elastomeric material, e.g., an elastic polymer. A variety of elastomeric polymeric materials are suitable for use with the invention, for example, polymers of the general classes of silicone polymers, epoxy polymers, and acrylate polymers. Epoxy polymers are characterized by the presence of a three-member cyclic ether group commonly referred to as an epoxy group, 1,2-epoxide, or oxirane. As specific examples, diglycidyl ethers of bisphenol A may be used, in addition to compounds based on aromatic amine, triazine, and cycloaliphatic backbones. Other examples include the well-known Novolac polymers, silicone elastomeric formed from precursors including the chlorosilanes such as methylchlorosilanes, ethylchlorosilanes, and phenylchlorosilanes, and the like. One preferred elastomeric polymer for use with the invention is polydimethylsiloxane (PDMS). Examples of polydimethylsiloxane polymers include those sold under the trademark Sylgard by the Dow Chemical Company, Midland, Mich., and particularly Sylgard 182, Sylgard 184, and Sylgard 186. Systems fabricated of PDMS may be fabricated using rapid prototyping and soft lithography. The microfluidic channels may be fabricated in PDMS using standard procedures (for example, see J. C. McDonald, G. M. Whitesides, Acc. Chem. Res. 35, 491 (2002)). Microcontact printing on surfaces and derivative articles and the formation of microstamped patterns on surfaces and derivative articles are discussed in Published Application No. WO 96/29629, published Jun. 26, 1996, by Whitesides, et al.; or U.S. Pat. No. 5,512,131, issued Apr. 30, 1996 to Kumar et al., each of which is hereby incorporated herein by reference.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Another advantage to forming microfluidic structures of the invention (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

The following examples are intended to illustrate certain embodiments of the present invention, but do not exemplify the full scope of the invention.

### EXAMPLE 1

This example describes a long (1 cm), laser-pumped, liquid core-liquid cladding (L²) waveguide laser, in accordance with one embodiment of the invention. The device in this example provides a simple, high intensity, tunable light source for microfluidic applications. As further discussed below, using a core solution of 2-mM rhodamine 640 perchlorate, optically pumped by a frequency-doubled Nd:YAG laser, the threshold for lasing was found to be as low as 28 microjoules (μJ) (16 ns pulse length) and had a slope efficiency up to 25%. The output wavelength was tunable over a 30-nm range by changing the ratio of solvent components (dimethyl sulfoxide (“DMSO”) and methanol) in the liquid core.

In this example, a liquid-liquid (L²) waveguide was used as the basis of a dye laser suitable for portable and/or low-cost systems. This system may reduce the threshold using a long lasing cavity. Certain aspects of the system can be used to simplify the liquid-handling and optical setup (e.g., by omitting moving mirrors, prisms, and gratings). In some cases, the laser may also be integrated into microfluidic networks. Dye lasers have several useful characteristics. For example, dye lasers can be used to provide sharp bright spectral lines that are tunable over a wide range of wavelengths (>30 nm for a single dye).

The structure of L² waveguides in this example is defined by the laminar flow of multiple liquid streams in a single microfluidic channel in an arrangement where one or two streams of a low refractive index fluid (the liquid cladding) envelop a third stream of high refractive index (the liquid core). L² waveguides are inherently dynamic systems which can be reconfigured, for example, by changing the dye, solvent composition, and/or the flow rates of the liquids, depending on a particular application. Thus, the L² waveguide may be tuned as desired. For instance, real-time and/or direct control of the characteristics of laser of the fluorescent waveguide may be achieved, for example control over emission wavelength, numerical aperture, absorbance, size, geometry, modal content, etc. In addition, in these devices, the optical interfaces forming the waveguide are created by the boundaries between laminarly flowing liquids within the waveguide. Thus, the requirements for the quality of microfabricated structures that form the waveguides do not necessarily have to be as high as is found in conventional waveguides. Thus, L² waveguides may be formed using an elastomeric matrix as the platform for a microfluidic laser, for instance, for facile integration within a microdevice.

FIG. 1A is a schematic representation of a microfluidic system fabricated using poly(dimethylsiloxane) with standard soft-lithographic techniques known to those of ordinary skill in the art. In FIG. 1A, the lasing cavity 15 of device 10 is shown as being a 10 mm long channel (400 micrometer×100 micrometer cross-section), terminating at both ends in T-junctions 11, 12. T-junctions 11, 12 could each be optionally coated with thin layers of gold 14 to act as mirrors for the lasing cavity. In FIG. 1A, device 10 is depicted as having a 100 nm thick gold mirror 13 near T-junction 11, and a 40 nm thick gold mirror 14 near T-junction 12.

A core fluid 17, containing a fluorescent dye (rhodamine 640 perchlorate), was provided from inlets 18 and 19 within device 15. Core fluid 17 was then passed through lasing cavity 15 to drains 21 and 22. Cladding stream fluids 23 and 24 (which may be the same or different) was provided from inlets 25 and 26, respectively. The cladding streams were also passed through lasing cavity 15 to drains 21 and 22. The streams were pressure-driven from both sides of T-junction 13 and down the length of the lasing cavity 15, forming the L² waveguide (in other cases, vacuum pressures may also be used). Mixing of the core and cladding streams occurred by diffusion, as the streams were flowing in the laminar regime (Reynolds number, Re ˜0.001-0.02).

Device 15 was excited using a 532 nm laser excitation beam (frequency doubled Nd:YAG, 50 Hz repetition rate, 16 ns pulse), elongated with a cylindrical lens (beam and lens not shown). The optical pumping region covered the full length of the lasing cavity 15 for a 10 mm long channel. In certain experiments, a lens was used to collect the laser radiation and focus it onto an optical fiber for input into a spectrometer for further analysis (0.2 nm resolution, USB2000, Ocean Optics).

For the initial characterization of a device as described above, 2 mM rhodamine 640 perchlorate in methanol was used as the core stream, and pure methanol as the cladding stream. At the rate of flow chosen in these experiments (4 to 32 mL/h), the incoming laser pump pulse (20 ms repetition rate) excited a given volume of the dye solution within the fluorescent core between 2 and 20 times (channel traversal times of 45-360 ms) (see Table 1, below). The dependence of the power of the output light on the flow rate within the above ranges was minimal (variation <20% for averaged power output). The diffusional mixing between the core and cladding streams was also found to be minimal (see below for more information). The rapid replacement of the dye, coupled with the short (˜16 ns) pulse length, reduced or eliminated problems associated with the absorption of the laser radiation by the long-lived triplet state and bleaching of the dye at power levels used (up to 0.15 mJ/pulse).

TABLE 1

| Total flow rate | Linear velocity | Channel transit time |
|---|---|---|
| (mL/h) | (m/s) | (s) |
| 4 | 0.0278 | 0.36 |
| 8 | 0.0556 | 0.18 |
| 12 | 0.0833 | 0.12 |
| 16 | 0.111 | 0.0901 |
| 32 | 0.222 | 0.0450 |
| 64 | 0.444 | 0.0223 |

This microfluidic waveguide laser was found to be able to produce high gain in a single pass (10 mm path being equivalent to 500 round trips in a 10 micrometer microcavity). A linewidth-narrowing and transition to amplified spontaneous emission (“ASE”) was observed in a device that did not have any mirrors at the front and back walls of the channel (i.e., mirrors 13 and 14 in FIG. 1A).

Additional details of the fabrication of the microfluidic devices follow. High resolution chrome masks were designed in Clewin (WieWeb Software) and printed with electron-beam lithography. The photoresist masters were made of SU-8-100 (Microchem, 3000 RPM; 100-micrometer thick) on silicon wafers (Silicon Sense, Inc, Nashua, N.H.) by standard photolithography with chrome masks. The surface of the photoresist master and silicon wafer were coated with tridecafluoro-1,1,2,2-tetrahydrooctyl-1-trichlorosilane (United Chemical Technology, PA) to lower the surface free energy; this coating allowed the poly(dimethylsiloxane) (PDMS, Dow, Sylgard 184) replica to be removed without damaging the master. PDMS was poured directly onto the master and cured for 2 hours at 60° C. The PDMS replica was removed under methanol to prevent damage to the features on the replica. A homemade punch was used to drill holes in the inlets and the outlets before sealing of the channels.

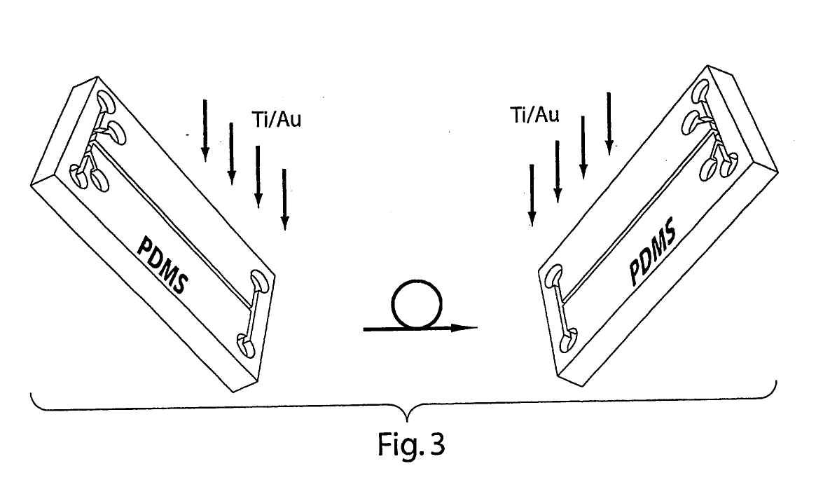

For certain devices, mirrors were evaporated onto the PDMS replica at the ends of the waveguide using electron beam evaporation (VEECO). The PDMS replica was placed on the evaporation stage at a 45° angle (see FIG. 3). This allowed one end of the device to be metal-coated. Rotating the PDMS replica by 180° allowed the other end of the device to be metal-coated. Both ends of the waveguide were then coated with an adhesion layer of Ti (5 nm) and a layer of Au (40-100 nm). The thickness of the gold layer determined the final reflectivity of the mirror. In a typical device, one end was coated with 40 nm of Au (˜70% reflectivity), and the other with 100 nm of Au (˜85% reflectivity). The excess gold coating the surface of the PDMS replica was removed with scotch tape.

The microfluidic channels were prepared by sealing the PDMS replica of the photoresist master to a flat piece of PDMS. The PDMS replica and the flat piece of PDMS were exposed to an oxygen plasma (Harrick PDC, Harrick, Pa.) for ˜60 s. The exposed surfaces were brought into contact with each other manually and allowed to seal. The sealed channels were placed in a quartered Petri dish with the output face placed ˜2 mm from the plastic dividers in the dish. Another layer of PDMS was poured and cured around the sealed channels for 2 hours at 60° C. This layer of PDMS conformed to the plastic divider in the Petri dish, producing an optically flat surface for the laser output. The channels were removed from the Petri dish.

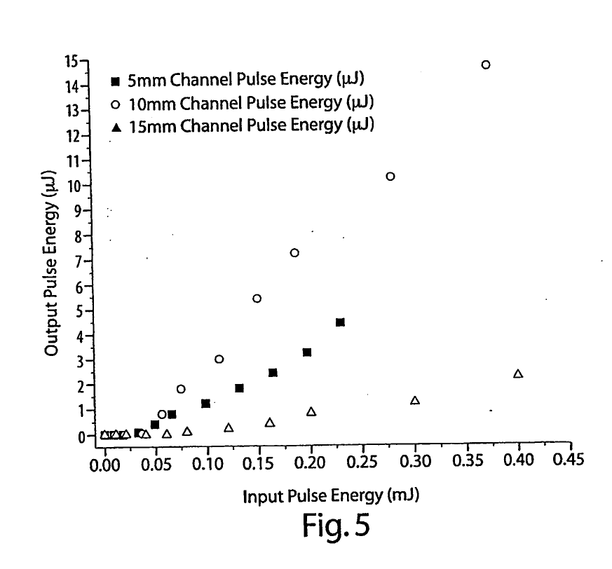

Rhodamine 640 perchlorate was chosen to characterize the device because of its use in other dye lasers. Methanol (n_{d}=1.323), ethylene glycol (EG, n_{d}=1.431), and methylsulfoxide (DMSO, n_{d}=1.479) were used as solvents to provide a range of refractive indices with which the L² waveguides were formed. The liquids were driven through the microfluidic device by syringe pumps (Genie, Kent Scientific Corporation, CT) at rates from 4 to 32 mL/h. In the waveguide, which formed the long axis of the device in FIG. 1A, two cladding flows (of methanol) sheathed the dye-containing central core flows (of methanol, ethylene glycol (“EG”), or DMSO). Smooth, generally linear interfaces between the core and cladding fluids allowed for low-loss guiding of light in a direction substantially aligned with the longitudinal axis. The roughness (r) in the walls of the PDMS channel did not appear to affect the interface of the two liquids as long as the width of the flowing cladding streams were each >2r. FIG. 5 shows the intensity of the output light versus input power for microfluidic channels of different lengths.

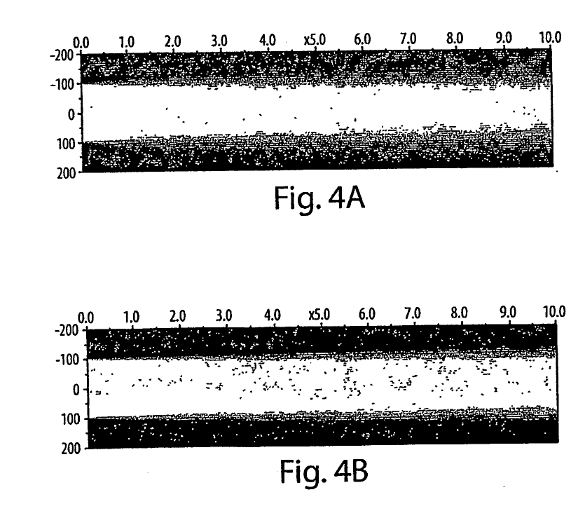

FIG. 4 shows the effect of diffusion on distribution of refractive index within microfluidic channel (10 mm long and 400 micrometer×100 micrometer cross-section): a top view of the two-dimensional refractive index distribution in the channel is shown for total flow rates of 4 mL/h (A) and 16 mL/h (B) for each inlet. A diffusion coefficient of ˜10⁻⁹ m²/s was used in these calculations.

### EXAMPLE 2

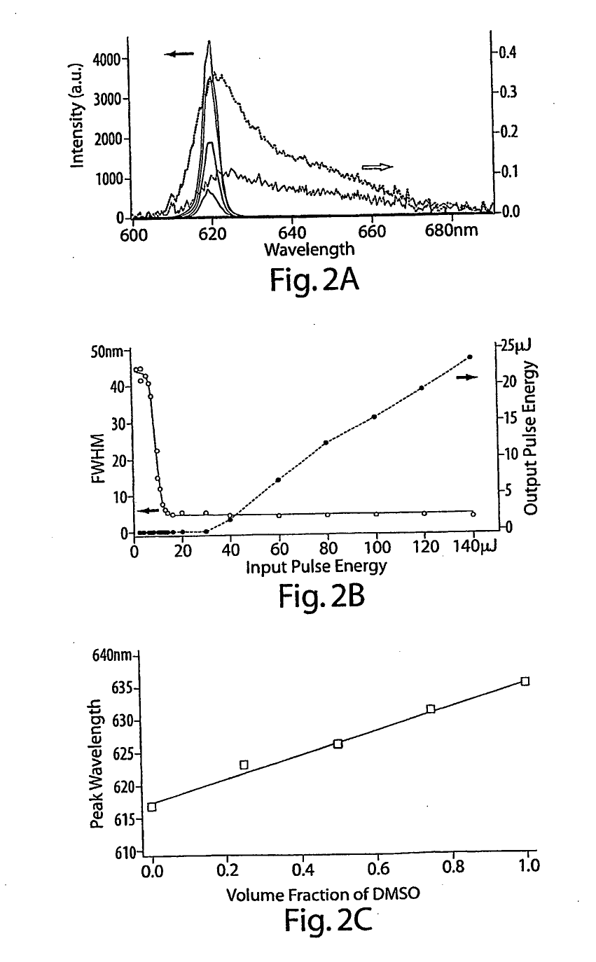

In this example, the light produced by a device similar to that described in Example 1 was characterized. FIG. 2A displays the spectral output of such a device over a range of optical pump intensities. L² waveguides terminated with gold mirrors produced a similar set of spectra. In FIG. 2A, the emission spectra from the L² fluorescent light source at different pump powers were measured on-axis, i.e., in a direction substantially aligned with the longitudinal axis. Note the 4 orders of magnitude difference in scale for spectra at input powers below (dashed) and above (solid) ASE threshold.

FIG. 2B is a plot of output power and line-width as a function of pump power for a device similar to that shown in FIG. 1A. The curves in FIG. 2B were drawn to guide the eye. The liquid core stream was 2 mM solution of the rhodamine 640 perchlorate in methanol, while the liquid cladding stream was methanol. At low pump power (<5 microjoules/pulse), the linewidth (full width at half maximum, “FWHM”) of the emission was found to be ˜45 nm with the maximum wavelength (λₘₐₓ, lambda-max) centered at ˜625 nm; these values were similar to those obtained for a cuvette of rhodamine 640 perchlorate in methanol using a UV-Vis spectrometer. The FWHM dropped by an order of magnitude to ˜4 nm between pump powers of between about 7 and about 16 microjoules. The rapid decrease in FWHM, and the drastic change in the slope in the plot of output power versus pump power (FIG. 2B) may indicate the onset of ASE at pulse energies of ˜10 microjoules. The linewidth of the output above the threshold was comparable to that of other microfluidic dye lasers. The plot of output light intensity versus pump power was well-described by an asymptotic formulas for ASE at low and high pump intensities (below and above saturation intensity for the transition, as further discussed below). The divergence angle obtained from such fits was found to be 80 miliradians, and was in reasonable agreement with direct experimental measurements of the beam divergence (25-45 milliradians).

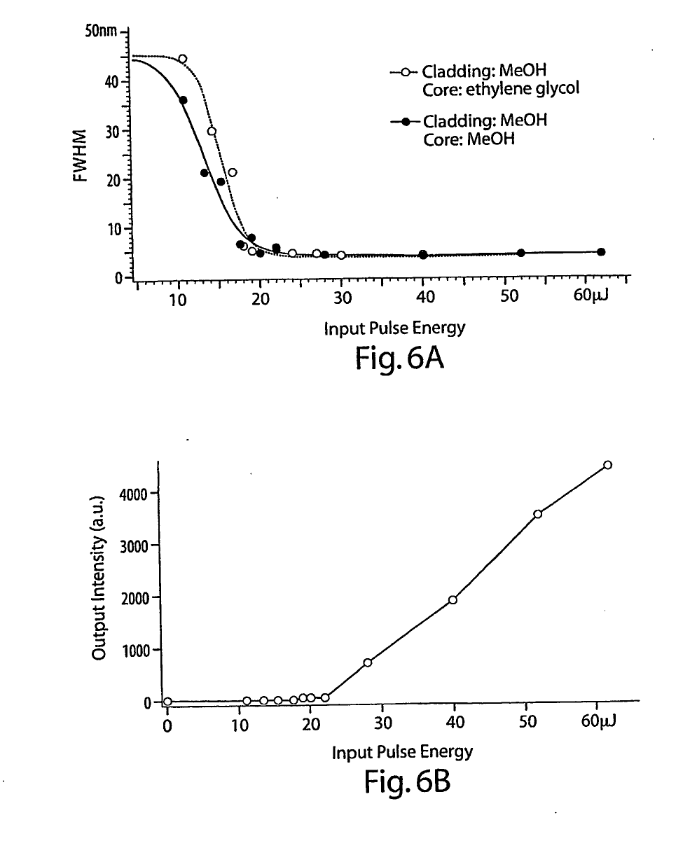

FIG. 6 shows ASE in L² waveguides devices without terminal mirrors, where the front and back walls of the microfluidic channels were uncoated. FIG. 6A shows output peak linewidth versus input pulse energy for 10 mm L² waveguides having methanol and ethylene glycol liquid core and methanol liquid cladding. The curves were sigmoidal fits to guide the eye. FIG. 6B shows output intensity for device having methanol core and cladding.

This L² waveguide system displayed a slope efficiency of approximately 10%, calculated as the ratio of measured power emitted by the dye in a direction substantially aligned with the longitudinal axis of the lasing cavity and the power of the pump laser absorbed by the device (e.g. incident power less ˜3% reflected by the PDMS-air interface and ˜7% transmitted through the device). These characteristics persisted when Au mirrors were introduced at the front and back PDMS walls forming the T-terminals of the lasing cavity (i.e., mirrors 13 and 14 in FIG. 1A). For methanol-core/methanol-cladding L² laser, the threshold for lasing occurs at 28 microjoules pulse energy (corresponding to 87.5 kW/cm² instantaneous or 70 mW/cm² average power density) displayed a slope efficiency of ˜20%.

### EXAMPLE 3

Using L² waveguides similar to those described above, in this example, the properties of the waveguide were modified by adjusting the refractive index contrast (Δn or delta-n, where Δn=n_{core}−n_{cladding}) between the core stream and the cladding stream. In this example, the contribution of residual reflectivity at the interface between the liquid core and the wall of the PDMS to transition to ASE in the lasing cavity without mirrors was also determined.

Interestingly, above- and below-threshold, the output characteristics (e.g., intensity and linewidth) of the ASE output were found to be very similar for methanol-core/methanol-cladding delta-n=0.0001) and for ethylene glycol (EG)-core/methanol-cladding (delta-n=0.1), as well as for a series of DMSO-methanol mixtures with methanol cladding (delta-n=0.0001−0.15), including the case where the liquid core was index-matched to the PDMS. A large difference in the slope of the transition to lasing close to the ASE threshold for waveguides with different delta-n was also observed. The transition was found to be much sharper for L² waveguides having a higher numerical aperture (“NA”˜delta-n), while systems with small values of delta-n showed spectral line narrowing at values of input power much lower than threshold. In addition to having a sharper transition to lasing, the systems with high delta-n, where the light was more strongly confined to the waveguide, had higher efficiencies of conversion and wider divergence angles (e.g. 24% and 80-100 milliradians, respectively, for EG-core and methanol-cladding) than the systems with low delta-n, where light was less strongly confined to the waveguide.

Changing the solvent in the fluorescent core provided a simple means of adjusting the wavelength of emission for a given dye without incorporating dispersive elements (prisms or gratings) into the lasing cavity. For example, the wavelength of the light output for Rhodamine 640 could be shifted by more than 20 nm by changing the composition of core liquid; lambda-max=617 nm for methanol, lambda-max=631 nm for EG, and lambda-max=634 nm for DMSO. Further, lambda-max could be tuned continuously by using a mixture of DMSO and methanol in the core and adjusting the ratio of these two components. For instance, FIG. 2C displays the linear relationship between the DMSO/methanol ratio and lambda-max at fixed dye concentration (2 mM) and pathlength (10 mm).

Thus, this example illustrates the use of a long-pathlength L² waveguide that is able to produce a narrow linewidth, low-threshold emission that is highly directional, even without the incorporation of mirrors. In-line mixing of solvents can provide a viable route to tuning the output wavelength in systems where dispersive elements (e.g. diffraction gratings or prisms) may be difficult to implement.

### EXAMPLE 4

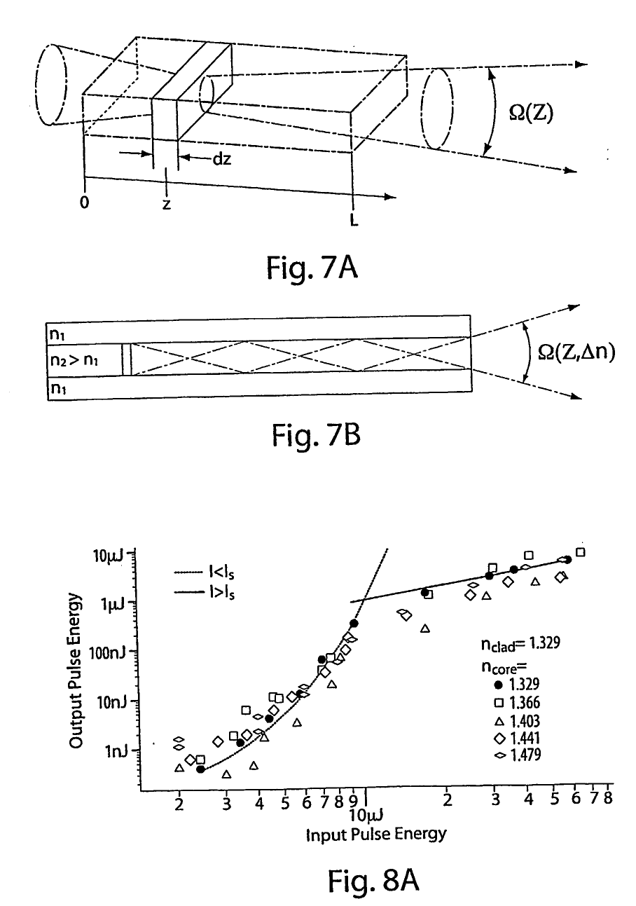

In this example, for a L² waveguide laser similar to those described above, the behavior of the ASE in the low and high gain saturation regimes can be described using analytical relationships, considered an active medium operating in a four-level scheme in a geometry given in the FIG. 7, which illustrates the geometry of the active medium for the ASE calculation in this example. Ω(z) is the solid angle subtended by the exit facet of the medium (at z=L) by active medium element dz. FIG. 7B illustrates the effect of waveguiding on divergence angle of ASE emission (n₁ and n₂ is the index of refraction of the liquid cladding and liquid core).

Since most ASE emission arises from elements near z=0, i.e. for Ω(z)=Ω(0)=Ω, for intensities, I, below the characteristic saturation intensity of the laser dye transition, Iₛ=hν₀/σₚτ (where h is Plank's constant, ν₀ is the peak transition frequency, σₚ is the peak cross-section, and τ is the lifetime of the transition), the total ASE intensity may be given by:

$$I = φ {I}_{s} ( \frac{Ω}{k} ) \frac{{( G - 1 )}^{3 / 2}}{{( G ln G )}^{1 / 2}} , \qquad ( 1 )$$

where k=4(π)^{3/2} for Lorentzian line, or k=4π for Gaussian line, φ is the quantum yield and G=exp(σₚNL) is the peak unsaturated gain of the amplifying medium (N is the inversion, L is the length of the optical path in the channel). In a deep saturation regime, a simple asymptotic expression can be obtained by assuming that half of available fluorescence power is contained in the beam propagating in one direction (and the other half in the beam in the opposite direction):

$$I = \frac{1}{2} φ {I}_{s} ln G . \qquad ( 2 )$$

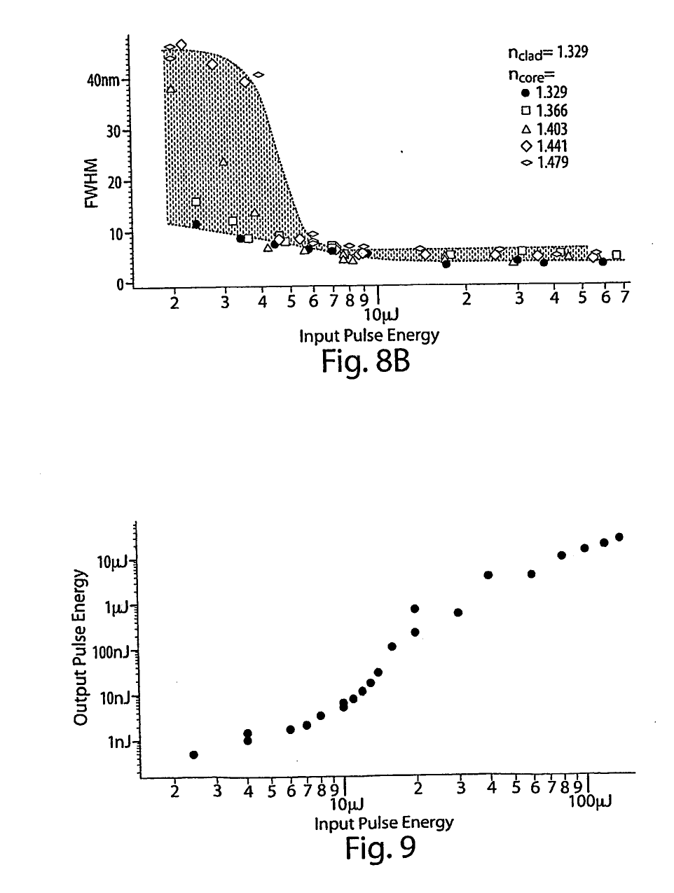

The data were fitted in FIG. 8 to Equations 1 and 2 by assuming N∝Iₚᵤₘₚ. The fitting described the experimental values well and led to a value of Ω˜0.007 steradian (or ˜80 miliradians) for beam divergence. In this figure, output pulse energy (FIG. 8A) and peak width (FIG. 8B) versus input pulse energy for 10 mm L² waveguides having liquid core of different refractive index are illustrated. The device in FIG. 8 did not have terminal mirrors, i.e., the front and back walls of the microfluidic channels were uncoated. In FIG. 8A, the curves were fits to two limiting regimes (below and above saturation for transition in laser dye) for methanol used as both liquid core and liquid cladding. In FIG. 8B, the curves are sigmoidal fits, used to guide the eye.

FIG. 9 illustrates the output pulse energy versus input pulse energy for 10 mm L² waveguide laser having terminal mirrors, where the front and back walls of the microfluidic channels are coated with 100 and 40 nm layers of gold, respectively. The device also had a methanol liquid core and liquid waveguide. The front and back walls of the microfluidic channels were coated with Au layers (40 and 100 nm).

### EXAMPLE 5

This example illustrates the tuning of certain microfluidic lasers of the invention. Certain microfluidic lasers were prepared, using techniques similar to those described above, and the tuning of these microfluidic lasers was demonstrated in this example.

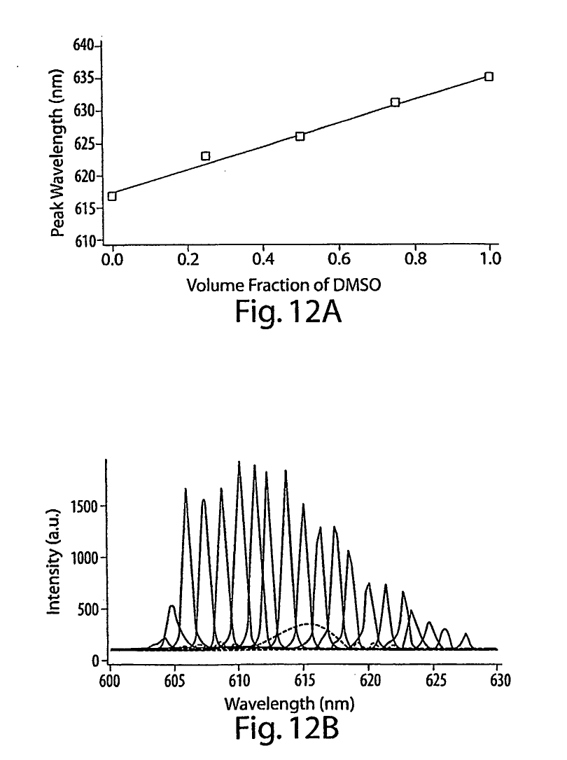

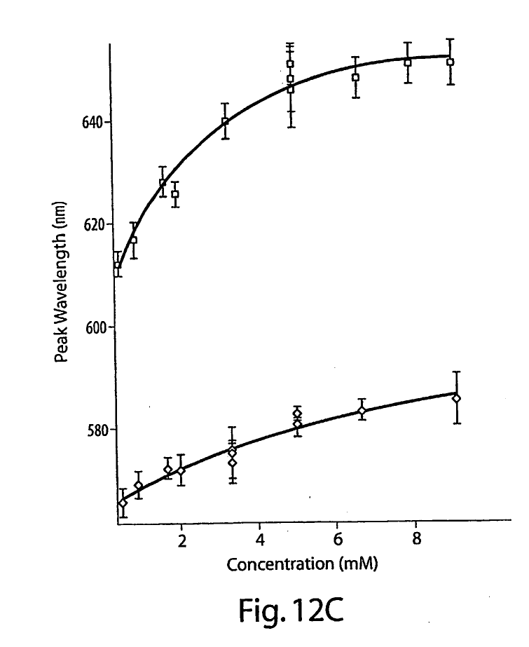

Referring now to FIGS. 12A-12C, in FIG. 12A, a microfluidic laser was tuned by altering the amount of solvent present with the lasing cavity of the microfluidic laser. The microfluidic laser was similar to that shown in FIG. 1A. The solvent used in this microfluidic laser was DMSO (dimethylsulfoxide). As the volume fraction of DMSO increased, the peak wavelength of the coherent radiation emitted by the lasing cavity increased in a generally linear manner.

In FIG. 12B, the coherent radiation emitted by a microfluidic laser was tuned using an external grating, using an apparatus similar to that illustrated in FIG. 11B. As shown in FIG. 12B, coherent light produced by the microfluidic laser, in conjunction with the grating, resulted in a series of individual peak intensities, with different spacings of the peak intensities controlled by the spacing of the grating.

FIG. 12C illustrates that the peak wavelength of coherent radiation emitted from a lasing cavity of a microfluidic laser could be controlled by controlling the concentration of the dye that is passed through the lasing cavity. The microfluidic laser had a configuration similar to that shown in FIG. 1A. Two difference dyes were separately used in this example, with their peak wavelengths indicated by squares and circles in FIG. 12C. The two different dyes used in the microfluidic laser resulted in different peak wavelengths of coherent radiation emitted from the laser. Moreover, the peak wavelength produced by each dye generally increased with increasing concentration of dye.

Thus, this example demonstrates that microfluidic lasers of the invention can be tuned using different techniques, depending on the particular application.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method comprising:
establishing lasing radiation in a liquid waveguide, contained within a microfluidic channel, comprising a first liquid defining a core and a second liquid surrounding the core and defining a cladding.

2. The method of claim 1, comprising establishing lasing radiation through emission and amplification within the core.

3. The method of claim 1, comprising:
establishing first lasing radiation in the liquid waveguide;
changing the size of the core, the cladding or both; and
then establishing second lasing radiation in the liquid waveguide.

4. The method of claim 1, comprising:
establishing first lasing radiation in the liquid waveguide;
changing the position of the core, the cladding or both; and
then establishing second lasing radiation in the liquid waveguide.

5. The method of claim 1, comprising:
establishing first lasing radiation in the liquid waveguide;
changing the index of refraction of the core, the cladding or both; and
then establishing second lasing radiation in the liquid waveguide.

6. The method of claim 1, comprising:
establishing first lasing radiation in the liquid waveguide;
changing the composition of the core, the cladding or both; and
then establishing second lasing radiation in the liquid waveguide.

7-10. (canceled)

11. The method of claim 6, comprising changing the composition of the core.

12. The method of claim 6, comprising changing the composition of the cladding.

13. The method of claim 1, wherein establishing lasing radiation comprises exciting a dye present within the microfluidic channel.

14. (canceled)

15. The method of claim 13, wherein the dye is fluorescent.

16. The method of claim 1, comprising producing the laser radiation in a direction substantially aligned with a longitudinal axis of the microfluidic channel.

17-40. (canceled)

41. An apparatus, comprising:
a first laser comprising a microfluidic channel defining a longitudinal axis, the first laser able to produce coherent light in a direction substantially aligned with the longitudinal axis; and
a second laser directed at the microfluidic channel of the first laser.

42-43. (canceled)

44. The apparatus of claim 41, wherein the microfluidic channel contains a first liquid and a second liquid not mixed with the first liquid.

45-46. (canceled)

47. The apparatus of claim 41, wherein the microfluidic channel comprises a dye.

48. (canceled)

49. The apparatus of claim 41, further comprising a diffractor.

50. The apparatus of claim 41, wherein the diffractor comprises a fluid.

51-80. (canceled)

81. An apparatus, comprising:
a laser comprising a microfluidic channel, the microfluidic channel containing a first liquid and a second liquid not mixed with the first liquid.

82. The apparatus of claim 81, wherein the laser is able to produce coherent light in a direction substantially aligned with a longitudinal axis of the microfluidic channel.

83-88. (canceled)

89. The apparatus of claim 81, further comprising a diffractor.

90. (canceled)

91. The apparatus of claim 81, further comprising a second laser directed at the microfluidic channel.

92-121. (canceled)
